(19) United States
(12) Patent Application Publication
(10) Pub. No.: US 2022/0156489 A1
(43) Pub. Date: May 19, 2022

(54) MACHINE LEARNING TECHNIQUES FOR IDENTIFYING LOGICAL SECTIONS IN UNSTRUCTURED DATA

(71) Applicant: Adobe Inc., San Jose, CA (US)

(72) Inventors: Rishav Agarwal, Uttar Pradesh (IN); Rishabh Purwar, Faridabad Haryana (IN); Abhishek Raj, Jharkhand (IN)

(21) Appl. No.: 16/951,983

(22) Filed: Nov. 18, 2020

(51) Int. Cl. G06K 9/00; G06N 3/04; G06F 40/284; G06F 40/30; G06F 17/18; G06F 17/16

(52) U.S. Cl. CPC G06K 9/00469; G06N 3/0454; G06F 17/16; G06F 40/30; G06F 17/18; G06F 40/284

(57) ABSTRACT

Methods and systems disclosed herein relate generally to systems and methods for using machine learning techniques to generate section identifiers for one or more sections of the unstructured or unformatted text data. A document-processing application identifies, with a feature-prediction layer of a machine-learning model, a feature representation that represents a semantic structure of a text section within the unformatted and unstructured document. The document-processing application generates, with a sequence-prediction layer of the machine-learning model, a section identifier (e.g., heading, body, list) for a corresponding text section by applying the sequence-prediction layer to the feature representation and using contextual information of neighboring text sections.

### TECHNICAL FIELD

This disclosure generally relates to methods that apply machine learning techniques for modifying or otherwise processing electronic content. More specifically, but not by way of limitation, this disclosure relates to using machine learning techniques to generate section identifiers for one or more sections of the unstructured or unformatted text data.

### BACKGROUND OF THE INVENTION

The volume of digital content written as text documents is growing every day, at an unprecedented rate. In particular, section identifiers (e.g., heading, list) in plain text could act as a precursor to many document-processing applications such as auto-stylizing unformatted text, font/style suggestion, text summarization, and topic detection. However, a large number of documents are unstructured. Identifying the section identifiers in the unstructured documents is largely a manual process that is time consuming, labor intensive, and costly. Existing techniques such as Natural Language Processing (NLP) and other Deep Learning techniques, have been applied to identify logical structures in a document. However, existing techniques rely on formatting information of the original text to identify structures therein. For instance, these techniques often involve identifying features such as text case (e.g., lowercase, uppercase) and features derived from the font (e.g., size, color, a font type distinct from other sections of the document) that are applied to the text. As such, existing techniques are ineffective for processing documents that do not include these or other types of formatting information.

### SUMMARY

Certain embodiments involve automatically detecting section identifiers (e.g., identifiers of a heading, a body, a list, etc.) in an unformatted and unstructured document. For instance, a document-processing application identifies, with a feature-prediction layer of a machine-learning model, a feature representation that represents a semantic structure of a given text section (e.g., a paragraph) within the unformatted and unstructured document. The document-processing application enhances the feature representation with additional paragraph-level features (e.g., number of words) to generate an enhanced feature representation of the text section. The document-processing application generates, with a sequence-prediction layer of the machine-learning model, a section identifier (e.g., heading, body, list) for a corresponding text section by applying the sequence-prediction layer to the enhanced feature representation and using contextual information of neighboring text sections.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates an example of a computing environment for identifying section identifiers in unstructured and unformatted data according to some embodiments.

FIG. 2 illustrates a process for identifying section identifiers in unstructured and unformatted data according to some embodiments.

FIG. 3 illustrates a configuration of a feature-prediction layer for identifying section identifiers in unstructured and unformatted data according to some embodiments.

FIG. 4A depicts an operation of an RNN for generating section identifiers for one or more sections of the unstructured or unformatted text data, according to some embodiments.

FIG. 4B illustrates an example of an RNN operation for generating section identifiers for one or more sections of the unstructured or unformatted text data, according to some embodiments.

FIG. 4C depicts an operation of an LSTM network for generating section identifiers for one or more sections of the unstructured or unformatted text data, according to some embodiments.

FIG. 4D illustrates a schematic diagram of a forget gate of an LSTM network, according to some embodiments.

FIG. 4E depicts a first phase operation of an input gate of an LSTM network according to some embodiments.

FIG. 4F depicts a second phase of an operation of an input gate of an LSTM network according to some embodiments.

FIG. 4G depicts an operation of an output gate of an LSTM network according to some embodiments.

FIG. 5 illustrates a schematic diagram of a machine-learning model used for identifying section identifiers in unstructured and unformatted data according to some embodiments.

FIG. 6 depicts a computing system that can implement any of the computing systems or environments according to some embodiments.

### DETAILED DESCRIPTION OF THE INVENTION

Certain embodiments described herein can address one or more of the problems identified above by using machine learning techniques to generate a section identifiers for one or more sections of the unstructured or unformatted text data. For instance, a document-processing application uses a feature-prediction layer of a machine-learning model to generate a representation of a semantic structure for corresponding text sections within the unformatted and unstructured document, and further uses a sequence-prediction layer to augment that representation with paragraph-level features and thereby generate a section identifier. A section identifier identifies a type of text section (e.g., heading, body, list) associated with the corresponding text section. The document-processing application applies the section identifier to the corresponding text sections to generate a formatted text document for subsequent text-processing operations.

In an illustrative example, a document-processing application accesses unstructured and unformatted input text data having multiple text sections. For instance, the document-processing application accesses a recipe document that includes a heading section, a first body section, a list section, and a second body section. In this example, the text document does not include any information (e.g., metadata, section identifiers) to indicate a type of text section for each of the four text sections of the text document.

Continuing with this example, the document-processing application identifies various text sections in the recipe document by identifying a sequence of text tokens ending with a newline character. The document-processing application generates a first feature that represents a first one of the identified text sections and a second feature that represents a second one of the identified text sections. To generate the first feature and the second feature, the document-processing application applies a feature-prediction layer of a machine-learning model to a first input embedding derived from the first text section and to a second input embedding derived from the second text section. The document-processing application or another software tool generates each input embedding by translating sparse vectors that represent words of a corresponding text section into a relatively low-dimensional vector that is the input embedding. This input embedding represents at least some of the semantics of the corresponding text section.

In this example, the document-processing application generates section identifiers for the first and second text sections of the recipe document based on a predicted contextual relationship between the first and second text sections. For instance, the document-processing application determines a predicted contextual relationship by applying a sequence-prediction layer of the machine-learning model to the first feature and the second feature. A contextual relationship indicates transitions between text sections and establishes a role of a particular text section in determining the prediction of the previous and subsequent section identifiers. The sequence-prediction layer is able to predict a contextual relationship by, for example, identifying one or more words (e.g., “following”) and/or characters (e.g., colon character) in a text section that are indicative of a transition to a different type of text section for a subsequent text section (e.g., list). The document-processing application generates a heading-section identifier for the first text section of the recipe document and a body-section identifier for the second text section of the recipe document based on the determined contextual relationship between the first and second sections. The document-processing application also generates the heading-section identifier and the body-section identifier based on the relationship between the two sections and other remaining sections of the recipe document.

The document-processing application generates a text document having the input text data augmented with section identifiers. For instance, the document-processing application applies the first section identifier to the first text section and applies the second section identifier to the second text section. As a result, the generated text document includes metadata (e.g., the section identifiers) that facilitate navigating to or otherwise identifying different text sections within the text document. Furthermore, the section identifiers also facilitate various other text-processing operations that can be performed on the formatted text document, including auto-stylizing of text sections, font/style suggestion, text summarization, table-of-contents generation, and topic detection. For instance, in the example in which the document-processing application generates a formatted recipe document, a text editing tool could modify visual characteristics of each text section in the recipe document by using the section identifiers to select a certain section (e.g., the first text section having a heading-section identifier, the second text section having a body-section identifier, etc.) and apply specific auto-formatting rules to that section (e.g., italicizing and enlarging the first text section because it is a header).

As described herein, certain embodiments provide improvements to software tools that use machine-learning models for modifying or otherwise processing digital text content. For instance, existing software tools that might rely on document metadata specifying certain formatting cues (e.g., font attributes specifying size or formatting) to identify sections of a document, which are unsuitable for input text without such metadata (e.g., text derived from an object character recognition process, plain text entered into an electronic form, etc.). Relying on these existing technologies could decrease the utility of editing tools that use section identifiers to modify or transform text, such as auto-formatting tools or text summarization tools. Embodiments described herein can facilitate an automated process for distinguishing and identifying text sections that avoids this reliance on ineffective technologies. For instance, the feature-prediction layer that extracts semantic features of text sections and sequence-prediction layer that utilizes contextual information to supplement the extracted features allows sections to be identified based on the semantic content of the text and relationship among text sections without regard to the formatting of the text. These features allow various embodiments herein to segment a wider variety of electronic document types than existing tools, thereby reducing manual, subjective efforts involved with segmenting unformatted or unstructured text more effectively than conventional techniques.

### Overall Environment for Identifying Section Identifiers in Unstructured and Unformatted Data

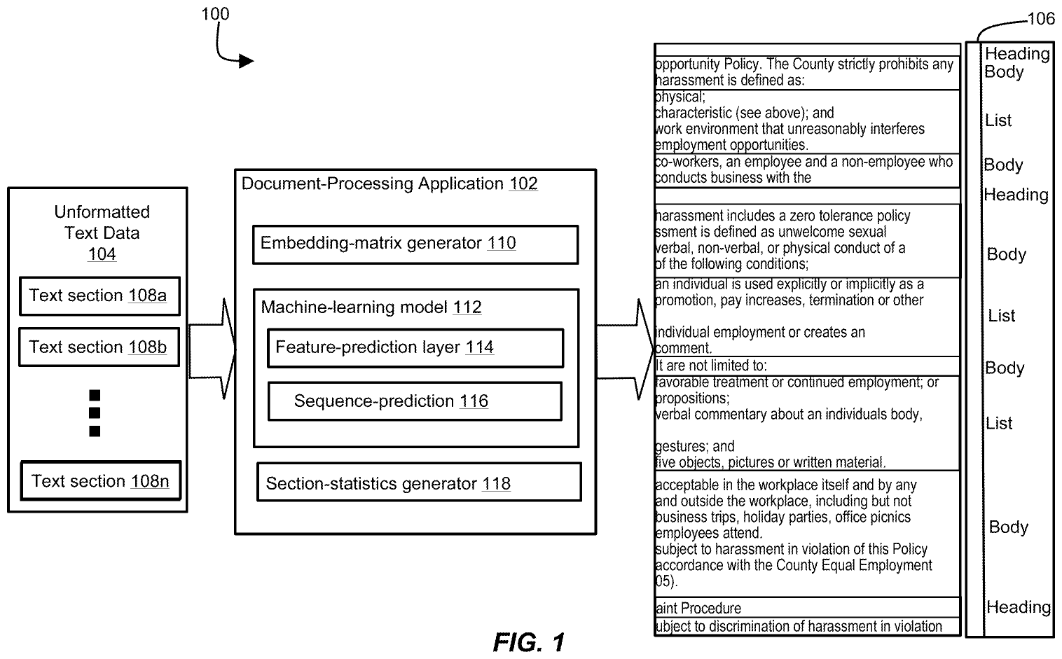

FIG. 1 illustrates an example of a computing environment 100 for identifying section identifiers in unstructured and unformatted data according to some embodiments. The computing environment 100 includes a document-processing application 102. The document-processing application 102 processes unformatted text data 104 to generate one or more section identifiers 106 that identify a type of text section (e.g., heading, body, list) associated with the corresponding text section. The unformatted text data 104 includes a sequence of text sections 108a-108n. In some instances, a text section includes a sequence of text tokens ending with a newline character. Additionally or alternatively, a text section can be identified by specifying a fixed number of word tokens (e.g., 120 tokens) to be associated with the text section.

The document-processing application 102 then uses an embedding-matrix generator 110 to generate an embedding matrix for each of the sequence of text sections 108a-108n. Specifically, the embedding-matrix generator 110 generates the embedding matrix for each of the sequence of text sections 108a-108n, such that the embedding matrix encodes one or more tokens of the text section. In some instances, the embedding matrix includes an identifier usable to identify a position of the text section (e.g., an index value) within the sequence of text sections 108a-108n. In each embedding matrix, the embedding-matrix generator 110 generates an input embedding for each token of the text section, in which the token includes one or more values that encodes a semantic definition of the token.

The document-processing application 104 then applies one or more layers of a machine-learning model 112 to process the embedding matrices representing the plurality of text sections 108a-108n and generate the section identifiers 106. The machine-learning model 112 includes a feature-prediction layer 114 and a sequence-prediction layer 116. The feature-prediction layer 114 transforms the embedding matrix of each of the plurality of text sections 108a-108n into a feature representation that identifies one or more semantic characteristics of the text section. In some instances, the feature-prediction layer 114 includes a convolutional neural network (CNN) that receives the embedding matrix and applies one or more convolutional layers to extract a feature representation of the text section. The document-processing application 102 uses the feature representations of the plurality of text sections 108a-108n to identify the section identifiers 106.

The sequence-prediction layer 116 processes the feature representation to generate a set of output features used by a fully-connected layer (for example) for identifying the section identifiers 106 for the plurality of text sections 108a-108n. In some instances, the sequence-prediction layer 116 identifies a section identifier for a particular text section by using a predicted contextual relationship between the text section and other text sections (e.g., previous text section, subsequent text section) of the unformatted text data 104. In some instances, the sequence-prediction layer 116 includes a recurrent neural network (“RNN”) for using the predicted contextual relationship to identify the section identifier. Additionally or alternatively, the sequence-prediction layer includes a long short term memory (“LSTM”) network, a type of an RNN, for using the predicted contextual relationship to identify the section identifier. The LSTM network can be a bidirectional LSTM network.

In some instances, a learned set of parameters from a given layer are used to train the other layer of the machine-learning model. For example, each iteration of the training process for the sequence-prediction layer 116 includes feeding the loss backwards through the network (e.g., backpropagation) to fine tune parameters of the feature-prediction layer 114. For example, word tokens such as “following” may not much of a factor for the feature-prediction layer in identifying a “body” identifier for a particular text section. However, such word tokens can be could be a strong indicator in identifying a “list” identifier for a subsequent text section. Features (e.g., “following”) learned in a particular layer (e.g., a sequence-prediction layer) can be propagated to optimize parameters of the other layer (e.g., a feature-prediction layer). Thus, the trained feature-prediction layer is likely to predict a “list” identifier for a subsequent text section of the text section having the word token “following.”

In some instances, a section-statistics generator 118 of the document-processing application 102 concatenates the feature representation with statistical features (e.g., length-frequency, syntax characteristics) corresponding to a text section. In some instances, the statistical features additionally include a frequency of uppercase characters appearing in the text section or a ratio between a count of uppercase characters and a count of words in the text section. ASCII values corresponding to one or more characters of the text section can also be considered as part of the statistical features. The statistical features facilitate a more complete representation of the text section by identifying syntax and other characteristics of the text section. For example, the section-statistics generator 118 identifies one or more statistical features of a given text section:
(a) Number of nouns;
(b) Number of verbs;
(c) Number of words;
(d) A ratio between a number of nouns and a number of words;
(e) A ratio between a number of verbs and a number of words;
(f) A ratio between a number of words with an uppercase character and a number of words;
(g) A ratio between cardinal numbers and a number of words;
(h) An ASCII value of the last character in the text section;
(i) An indication whether all tokens in the text section includes one or more uppercase characters;
(j) Number of sentences;
(k) A ratio between a number of same words in a previous text section and a number of words;
(l) A ratio between a number of words with all uppercasing and a number of words; and
(m) A number of cardinal numbers.

The section identifiers 106 augment text data of an output text document. For example, the document-processing application 102 applies a heading identifier (“Abstract”) to a text section of the plurality of text sections 108a-108n and a sub-heading identifier (“1.1.1 Nearest Neighbor (NN)”) to another text section. As a result, the text document generated by the document-processing application 102 includes metadata (e.g., the section identifiers) that facilitate navigating to or otherwise identifying different text sections within the text document. Furthermore, the section identifiers also facilitate various other text-processing operations that can be performed on the formatted text document, including auto-stylizing of text sections, font/style suggestion, text summarization, table-of-contents generation, and topic detection.

### Overall Process for Identifying Section Identifiers in Unstructured and Unformatted Data

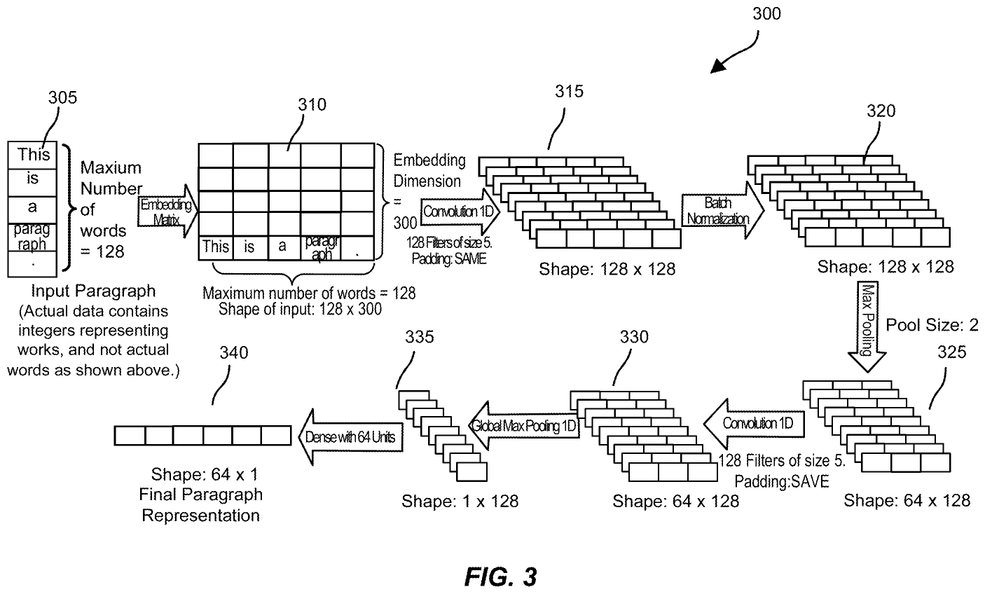

FIG. 2 illustrates a process 200 for identifying section identifiers in unstructured and unformatted data according to some embodiments. For illustrative purposes, the process 200 is described with reference to the components illustrated in FIG. 1, though other implementations are possible. For example, the program code for a document-processing application 102 of FIG. 1, which is stored in a non-transitory computer-readable medium, is executed by one or more processing devices to cause the server system 102 to perform one or more operations described herein.

At step 202, the document-processing application accesses unstructured and unformatted input text data having a first text section and a second text section. The unstructured and unformatted input text data does not include any information (e.g., metadata, section identifiers) to indicate a type of text section for each of a plurality of text sections in the input text data. In some instances, the document-processing application identifies first text section and the second text sections by identifying a sequence of text tokens ending with a newline character. Additionally or alternatively, a text section can be identified by specifying a fixed number of word tokens (e.g., 120 tokens) to be associated with the text section.

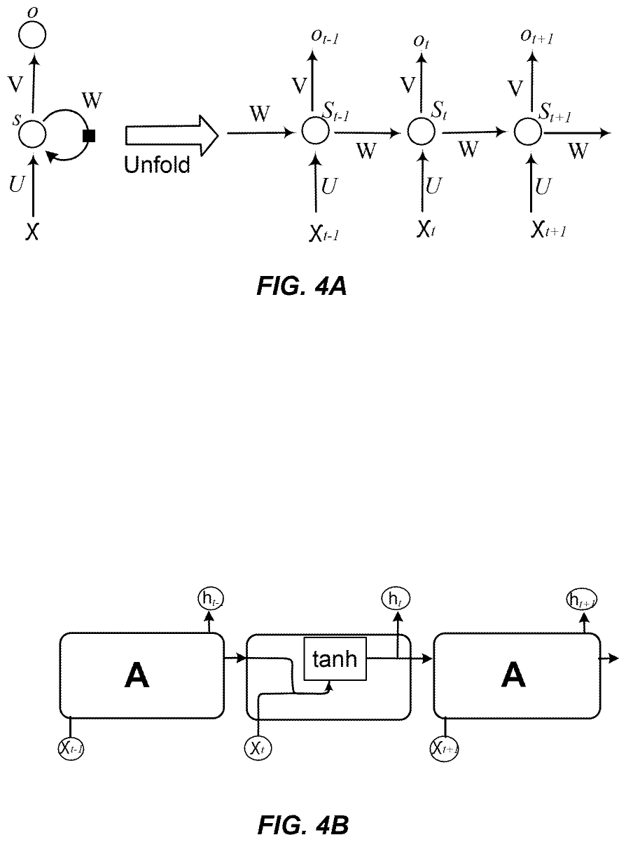

At step 204, the document-processing application generates a first feature that represents the first text section by, at least, applying a feature-prediction layer of a machine-learning model to a first input embedding derived from the first text section. In particular, the document-processing application applies the feature-prediction layer (e.g., a CNN) to the first input embedding to generate the first feature (e.g. a vector including a set of values) corresponding to the first text section. The document-processing application or another software tool generates the first input embedding by translating sparse vectors that represent words of the first text section into a relatively low-dimensional vector that is the input embedding. The first input embedding thus represents at least some of the semantics of the first text section. A detailed example for performing step 204 is described herein with respect to FIG. 3.

In some instances, the document-processing application uses a pre-trained language model (e.g., word2vec, fastText) to encode each word token of the first text section into a corresponding input embedding. The document-processing application combines the input embeddings of the tokens into an embedding matrix that represents the word tokens of the first text section.

At step 206, the document-processing application generates a second feature that represents the second text section by, at least, applying a feature-prediction layer of a machine-learning model to a second input embedding derived from the second text section. Similar to step 204, the document-processing application applies the feature-prediction layer to the second input embedding to generate the second feature corresponding to the second text section. The second input embedding represents at least some of the semantics of the second text section. A detailed example for performing step 206 is described herein with respect to FIG. 3.

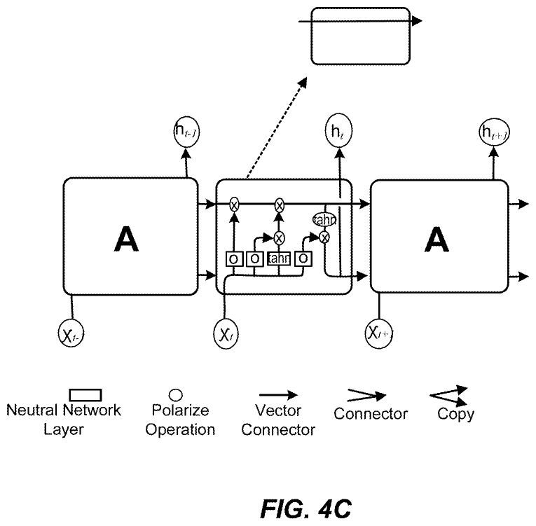

At step 208, the document-processing application identifies a first section identifier for the first text section and a second section identifier for the second text section based on a predicted contextual relationship between the first text section and the second text section. In some instances, the document-processing application determines the predicted contextual relationship by applying a sequence-prediction layer of the machine-learning model to the first feature and the second feature. The contextual relationship identifies transitions between the first and second text sections and identifies a role of a given text section (e.g., the second text section) in determining the prediction of the previous and subsequent section identifiers (e.g., the first text section). In some instances, the sequence-prediction layer includes an LSTM network. A detailed example for performing step 208 is described herein with respect to FIGS. 4A-G.

At step 210, the document-processing application 102 generates a text document having the input text data, the first section identifier applied to the first text section, and the second section identifier applied to the second text section. In some instances, the document-processing application applies the first section identifier is to the first text section and applies the second section identifier to the second text section. As a result, the generated text document includes metadata (e.g., the section identifiers) that facilitate navigating to or otherwise identifying different text sections within the text document. Process 200 terminates thereafter.

### Machine-Learning Model

The document-processing application uses machine learning techniques to generate section identifiers for one or more sections of the unstructured or unformatted text data. In particular, the document-processing application uses a machine-learning model that includes a feature-prediction layer and a sequence-prediction layer for identifying a section identifier for a given text section of the text data. The document-processing application uses the feature-prediction layer (e.g., 1-dimensional convolutional neural network) to generate a feature representation of a text section. In some instances, the feature representation is concatenated with a set of values corresponding to length-frequency and syntax characteristics of the text section. The document-processing application also applies the sequence-prediction layer (e.g., a recurrent neural network) to a sequence of the feature representations generated by the feature-prediction layer, so as to correlate each text section to other text sections. A contextual relationship predicted between the text sections is used to determine a section identifier that identifies a type of text section (e.g., heading, body, list) associated with the corresponding text section.

Each of the layers of the machine-learning model can be trained using a training dataset. For example, a training dataset includes a set of documents (e.g., 7000 PDF documents), in which each document includes one or more text sections that are associated with their respective section identifiers. The section identifiers include a type of text section, such as Title, Heading-1, Sub-Heading (e.g., Heading-2), Sub-Sub-Heading (e.g., Heading-3), Paragraph, Table, List, Blockquotes, EndNotes, Footnotes, etc. To train the machine-learning models, the section identifiers are removed from each document, and outputs generated from the machine-learning models are compared with the removed section identifiers for backpropagation. In some instances, one or more text sections of text are omitted from the training dataset based on their respective section identifiers.

1. Feature-Prediction Layer

FIG. 3 illustrates a configuration 300 of a feature-prediction layer for identifying section identifiers in unstructured and unformatted data according to some embodiments. The feature-prediction layer includes a CNN that identifies a feature representation (e.g. a vector including a set of values) corresponding to each text section of an unstructured and unformatted text data. The CNN receives an embedding matrix that represents a given text section, then applies one or more convolutional layers to extract a feature representation of the text section. In some instances, a sequence model is used as an alternative to the CNN. However, using the CNN for feature prediction reduces computational cost, with comparable performance levels.

A document-processing application receives a text section 305 that includes a plurality of tokens (e.g., words, punctuation characters). The document-processing application encodes each token into an input embedding (e.g., a vector represented by a plurality of values) based on its semantic characteristics. In some instances, the document-processing application is configured to generate input embedding with a predefined number of dimensions. For example, as shown in FIG. 3, the document-processing application encodes a fourth token of the text section 305 (“paragraph”) into an input embedding with 300 dimensions. Thus, the token “paragraph” is represented by 300 real number values. In some instances, the document-processing application uses a pre-trained model (e.g., word2vec, fastText) to encode each token into an input embedding. The input embeddings for the tokens are combined into an embedding matrix 310 that represents the tokens of the text section 305. In some instances, the document-processing application determines a maximum width of the embedding matrix 310, For example, the maximum width of the embedding matrix 310 is 128, which indicates a word limit of 128 for a given text section. The document-processing application then avails the embedding matrix 310 for the feature-prediction layer (e.g., the CNN).

The CNN accesses the embedding matrix 310 of the text section and applies a series of operations which form a single convolutional layer: (1) convolution; (2) batch normalization; and (3) max-pooling. To perform convolution, the CNN applies one or more filters including a matrix of values that can “slide over” the embedding matrix 310 so as to generate a set of feature maps 315. A filter includes a matrix of numbers that are different from a matrix values of another filter, in order to allow the filter to extract different features from the embedding matrix 310. In some instances, a set of hyperparameters that correspond to the feature map generation are predefined (e.g., based on manual input). Feature-extraction hyperparameters may identify (for example) a number of filters, a stride for each filter (e.g., 1-step, 2-step), a padding size, a kernel size, and/or a kernel shape. For example, as shown in FIG. 3, the CNN applies 128 filters, each of which having a kernel size of 5. As a result, 128 feature maps are generated for the text section 305.

Continuing with the example of FIG. 3, the CNN performs a batch normalization operation on the set of feature maps 315 to generate a set of normalized feature maps 320. As used herein, batch normalization is a supervised learning technique that normalizes interlayer outputs (e.g., the set of feature maps 315) of a neural network into a standard format. Batch normalization effectively ‘resets’ a distribution of the output of the previous layer to be more efficiently processed by the subsequent layer.

After the batch normalization operation, the CNN performs a pooling operation on the set of normalized feature maps 320 in order to reduce the spatial size of each feature map and subsequently generate a set of pooled feature maps 325. In some embodiments, the CNN performs the pooling operation to reduce dimensionality of the set of normalized feature maps 320, while retaining the semantic features captured by the embedding matrix 310. In some instances, the CNN system performs a max pooling operation to access a group of values within the feature map (e.g., 2 values within the feature map) and selects an element associated with the highest value. This operation can be iterated to traverse the entirety of each feature map of the set of normalized feature maps 320, at which the max pooling operation completes the generation of the set of pooled feature maps 325. For example, as shown in FIG. 3, the CNN sets a pool size of 2 and reduces dimensions for each feature map of the set of normalized feature maps 320 (“128”) by half (“64”). As a result, a dimensionality for each pooled feature map 325 is 64.

The CNN system may alternatively or additionally perform an average pooling operation in place of the max pooling operation which selects the sum or average value of the elements captured in the area within the feature map. By performing the pooling operations, the CNN system may achieve several technical advantages including capability of generating an input representation of the embedding matrix 310 that allows reduction of number of parameters and computations within the CNN model.

Continuing with the example of FIG. 3, the CNN continues to apply one or more additional convolutional layers at which convolution and pooling operations are performed on the set of pooled feature maps 325. For example, the CNN generates a second set of feature maps 330 by applying another set of filters to each feature map of the set of pooled feature maps 325.

In addition, the CNN applies a global max pooling operation on the second set of feature maps 330 such that a maximum value for each feature map is selected to form a second set of pooled feature maps 335.

The CNN applies a fully connected layer (alternatively, a dense layer) to the second set of pooled feature maps 335 to generate a feature representation 340 of the text section 305. The fully connected layer includes a multi-layer perceptron network incorporating a softmax activation function or other types of linear or non-linear functions at an output layer. In some instances, the CNN uses the fully connected layer that accesses the extracted features and generates an output that includes a feature representation that identifies one or more semantic characteristics of the text section. For example, as shown in FIG. 3, the feature representation 340 of the text section 305 is an array of values having an array size of 64. In some instances, the CNN performs the above operations through the remaining text sections of the text data, thereby generating a feature representations for all text sections of the text data.

The feature representation 340 can then be used as an input for the sequence-prediction layer, which then performs a series of operations for identifying a section identifiers corresponding to the text section 305. In some instances, the output and the labels of the training dataset are used as input for loss functions to optimize the parameters in the CNN. An error value generated by the loss functions is used in backpropagation algorithms to adjust the parameters in the CNN and thus improve the accuracy of subsequent feature representations outputted by the CNN. The feature representation 340 is an example of a feature generated in steps 204 or 206 from process 200 in FIG. 2 as described above.

It will be appreciated that, while FIG. 3 depicts using two convolutional layers to process the embedding matrix 310, different number of convolutional layers may be used (e.g., which may have an effect of repeating these operations can be repeated by the CNN system one or more times). In some instances, pooling operations are omitted for one or more convolutional layers applied by the CNN system. Different versions of the CNN architecture can be used by the CNN system, including but not limited to AlexNet, ZF Net, GoogLeNet, VGGNet, ResNets, DenseNet, etc.

2. Sequence-Prediction Layer

A sequence-prediction layer receives a feature representation for each of the text sections generated by the feature-prediction layer. The feature representation of a given text section includes a set of values that identify one or more semantic characteristics of the text section and may be combined with statistical features (e.g., length-frequency, syntax characteristics) of the text section. The sequence-prediction layer processes the feature representation to generate a set of output features used by a fully-connected layer (for example) for identifying a section identifier for the text section. In some instances, the sequence-prediction layer identifies a section identifier for a given text section by using a predicted contextual relationship between the text section and other text sections of the text data. In some instances, the sequence-prediction layer includes an RNN. Additionally or alternatively, the sequence-prediction layer includes an LSTM network, which is a type of an RNN. The LSTM network can be a bidirectional LSTM network.

With the sequence-prediction layer, the document-processing application detects transitions between text sections and establishes a role of a particular text section in determining the prediction of the previous and subsequent section identifiers. Thus, the sequence-prediction layer not only compares how similar or different text sections are to detect transitions, but also identifies which features in the particular text section are indicative of the prediction of section identifiers for other text sections in the text data.

FIG. 4A depicts an operation of an RNN for generating section identifiers for one or more sections of the unstructured or unformatted text data, according to some embodiments. RNNs include a chain of repeating modules (“cell”) of a neural network. Specifically, an operation of an RNN includes repeating a single cell indexed by a position of a text section (t) within the text sections of the text data. In order to provide its recurrent behavior, an RNN maintains a hidden state sₜ, which is provided as input to the next iteration of the network. As referred herein, variables sₜ and hₜ are used interchangeably to represent a hidden state of the RNN. As shown in the left portion of FIG. 4A, an RNN receives a feature representation for the text section xₜ and a hidden state value sₜ₋₁ determined using sets of input features of the previous text sections. The following equation provides how the hidden state sₜ is determined:

sₜ=φ(Uxₜ+Wsₜ₋₁),
where U and W are weight values applied to xₜ and sₜ₋₁ respectively, and φ is a non-linear function such as tan h or ReLU.

The output of the recurrent neural network is expressed as:

oₜ=softmax(Vsₜ),

where V is a weight value applied to the hidden state value sₜ.

Thus, the hidden state sₜ can be referred to as the memory of the network. In other words, the hidden state sₜ depends from information associated with inputs and/or outputs used or otherwise derived from one or more previous text sections. The output at step oₜ is a set of values used to identify section identifier for the text section, which is calculated based at least in part on the memory at text section position t.

FIG. 4B illustrates an example of an RNN operation for generating section identifiers for one or more sections of the unstructured or unformatted text data, according to some embodiments. FIG. 4B depicts the RNN, in which the network has been unrolled for clarity. In FIG. 4B, φ is specifically shown as the tan h function and the linear weights U, V and W are not explicitly shown. Unlike a traditional deep neural network, which uses different parameters at each layer, an RNN shares the same parameters (U, V, W above) across all text sections. This reflects the fact that the same task is being performed at each text-section position, with different inputs. This greatly reduces the total number of parameters to be learned.

FIG. 4C depicts an operation of an LSTM network for generating section identifiers for one or more sections of the unstructured or unformatted text data, according to some embodiments. As explained above, the sequence-prediction layer can include the LSTM network to identify section identifiers for text sections in the unstructured and unformatted text data. An LSTM network is a type of an RNN, in which the LSTM network learns long-term dependencies between text sections. In some instances, the LSTM network is a bidirectional LSTM network. The bidirectional LSTM network applies two LSTM network layers to the input features of the text sections: (i) a first LSTM network layer trained to process input features of the text sections according to a forward sequence of text sections in the text data (e.g., first text section to last text section); and (ii) a second LSTM network layer trained to process input features of the text sections according to a reverse sequence of text sections in the text data (e.g., last text section to first text section).

As shown in FIG. 4C, an LSTM network may comprise a series of cells, similar to RNNs shown in FIGS. 4A-4B. Similar to an RNN, each cell in the LSTM network operates to compute a new hidden state for the next time step.

In addition to maintaining and updating a hidden state sₜ, the LSTM network maintains a cell state Cₜ. As used herein, a cell state encodes information of the inputs that have been observed up to that step (at every step). In some embodiments, rather than using a single layer for a standard RNN such as the tan h layer shown in FIG. 4B, the LSTM network includes a second layer for adding and removing information from the cell via a set of gates. A gate includes a sigmoid function coupled to a pointwise or Hadamard product multiplication function, where the sigmoid function is:

$$\begin{matrix} \text{?} = \frac{1}{1 + \text{?}} & \\ \text{?} \text{indicates text missing or illegible when filed} & \end{matrix}$$

The ⊗ symbol or the ∘ symbol represents the Hadamard product. Gates can allow or disallow the flow of information through the cell. As the sigmoid function results in a value between 0 and 1, the functions value affects how much of each feature of a previous text section should be allowed through a gate. Referring again to FIG. 4C, an LSTM network cell includes three gates: a forget gate; an input gate; and an output gate.

FIG. 4D illustrates a schematic diagram of a forget gate of an LSTM network, according to some embodiments. The LSTM network uses a forget gate to determine what information to discard in the cell state (long-term memory) based on the previous hidden state hₜ₋₁ and the current input xₜ. The LSTM network passes information from hₜ₋₁ and information from xₜ through a sigmoid function of the hidden gate. The output of the forget gate includes a value between 0 and 1. The LSTM network determines an output closer to 0 as information to forget. Conversely, the LSTM network determines an output closer to 1 as information to keep. An output value of the forget gate fₜ may be represented as:

fₜ=σ(W_{f}[hₜ₋₁,xₜ]+b_{f}),

where W_{f} is a scalar constant, b_{f} is a bias term, and the brackets indicate concatenation of the input values.

FIGS. 4E-4F depict an operation of an input gate of an LSTM network, according to some embodiments. The LSTM network performs an input gate operation two phases, which are shown respectively in FIGS. 4E and 4F. For example, FIG. 4E depicts a first phase operation of an input gate of the LSTM network according to some embodiments. The first phase operation includes the LSTM network passing the previous hidden state and current input into a sigmoid function. The sigmoid function converts the input values (hₜ₋₁, xₜ) to determine whether the values of the cell state should be updated by transforming the input values a value between 0 and 1. In some instances, 0 indicates a value of less importance, and 1 indicates a value of more importance. In addition, the LSTM network passes the hidden state and current input into a tan h function to squish the input values between −1 and 1 to help regulate the network. The tan h function thus creates a vector of new candidate values \tilde{C}ₜ that may be added to the cell state. An output value of the sigmoid function iₜ may be expressed by the following equation:

iₜ=σ(Wᵢ[hₜ₋₁,xₜ]+bᵢ)

In addition, an output value of the tan h function \tilde{C}ₜ may be expressed by the following equation

\tilde{C}ₜ=tan h(W_{c}[hₜ₋₁,xₜ]+b_{c})

FIG. 4F depicts a second phase of an operation of an input gate of an LSTM network, according to some embodiments. As shown in FIG. 4F, the old state Cₜ₋₁ may be multiplied by the output value of the forget gate fₜ to facilitate forgetting of information corresponding to the input values to the forget gate. Thereafter the new candidate values of the cell state iₜ⊗\tilde{C}ₜ are added to the previous cell state Cₜ₋₁ via pointwise addition. This may be expressed by the relation:

Cₜ=fₜ⊗Cₜ₋₁+iₜ⊗\tilde{C}ₜ

FIG. 4G depicts an operation of an output gate of an LSTM network according to some embodiments. The LSTM network uses the output gate to generate an output by applying a value corresponding to a cell state Cₜ. The output gate decides what the next hidden state should be. Remember that the hidden state contains information on previous inputs. The hidden state is also used for predictions. First, we pass the previous hidden state and the current input into a sigmoid function. Then we pass the newly modified cell state to the tan h function. We multiply the tan h output with the sigmoid output to decide what information the hidden state should carry. The output is the hidden state. The new cell state and the new hidden is then carried over to the next time step.

For example, the LSTM network passes the input values hₜ₋₁, xₜ to a sigmoid function. The LSTM network applies a tan h function to a cell state Cₜ, which was modified by the forget gate and the input gate. The LSTM network then multiplies the output of the tan h function (e.g., a value between −1 and 1 that represents the cell state) with the output of the sigmoid function. The LSTM network retrieves the hidden state determined from the output gate (e.g., return_sequence=true), and assigns the hidden state as a set of output features used for identifying the section identifier for the text section. For example, a fully connected neural network processes a given output feature to identify a corresponding section identifier. The identified section identifier is an example of a feature generated in step 208 from process 200 in FIG. 2 as described above. The LSTM network may continue such retrieval process such that the set of output features are determined for the text sections of the unformatted and unstructured text data. In some instances, the output of the output gate is a new hidden state that is to be used for a subsequent text section of the text data. The operations of an output gate can be expressed by the following equations:

oₜ=σ(Wₒ[hₜ₋₁,xₜ]+bₒ)

hₜ=oₜ⊗ tan h(Cₜ)

The LSTM network as depicted in FIGS. 4C-4G is only one example that the sequence-prediction layer uses to identify a section identifier for a given text section. Thus, a gated recurrent unit (“GRU”) may be used or some other variant of an RNN. In addition, one ordinarily skilled in the art will recognize that the internal structures as shown in FIGS. 4C-4G can be modified in a multitude of ways, for example, to include peephole connections.

3. Backpropagation Between Feature-Prediction and Sequence-Prediction Layers

The feature-prediction layer and the sequence-prediction layer can be trained together to optimize their respective parameters. During training, the output features from a given layer are used as input to train the other layer of the machine-learning model. For example, each iteration of the training process for a sequence-prediction layer includes feeding the loss backwards through the network (e.g., backpropagation) to fine tune parameters of the feature-prediction layer. In other words, an error value generated by a loss function of the sequence-prediction layer is backpropagated to adjust the parameters in the feature-prediction layer. Thus, the features identified in the feature-prediction layer are used not only to predict a section identifier for a single text section, but also used as features for predicting section identifiers for other text sections in the text data. Such configuration is advantageous over conventional techniques by increasing accuracy of predicting section identifiers in the text data.

As another illustrative example, word tokens such as “following” may not much of a factor for the feature-prediction layer in identifying a “body” identifier for a particular text section. However, such word tokens can be could be a strong indicator in identifying a “list” identifier for a subsequent text section. Features (e.g., “following”) learned in a particular layer (e.g., a sequence-prediction layer) can be propagated to optimize parameters of the other layer (e.g., a feature-prediction layer). Thus, the trained feature-prediction layer is likely to predict a “list” identifier for a subsequent text section of the text section having the word token “following.”

It will be appreciated by one skilled in the art that various backpropagation algorithms can be used for training the feature-prediction layer and the sequence-prediction layer. Example algorithms include gradient techniques, such as gradient descent or stochastic average gradient, as well as other techniques of higher order such as conjugate gradient, Newton, quasi-Newton, or Levenberg-Marquardt.

### Generating Section Identifiers for One or More Sections of the Unstructured or Unformatted Text Data

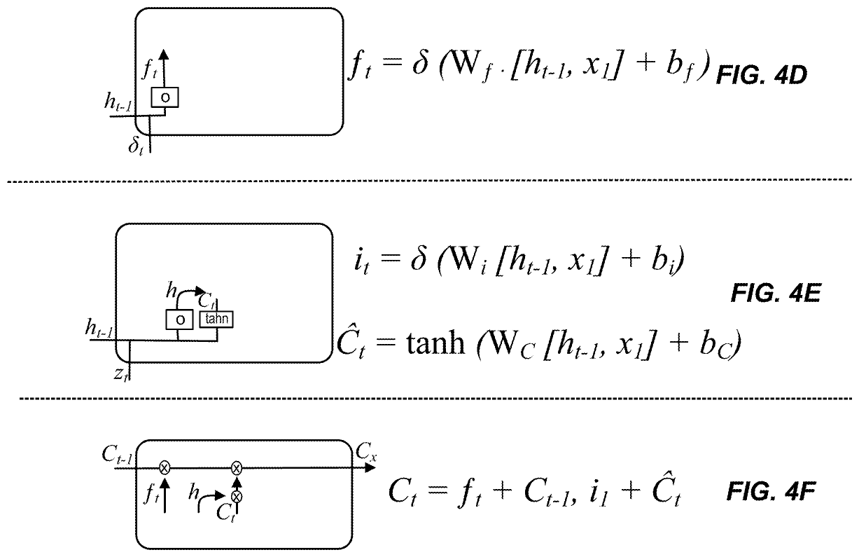

FIG. 5 illustrates a schematic diagram of a machine-learning model 500 used for identifying section identifiers in unstructured and unformatted data, according to some embodiments. The machine-learning model 500 is a single unified model that includes a feature-prediction layer 505, a section-statistics generator 510, and a sequence-prediction layer 515, in which a text section is processed to identify a final output 520 (e.g., section identifiers). The feature-prediction layer 505 includes a CNN that extracts the paragraph level features for a given paragraph. The sequence-prediction layer 515 uses sequence of the feature representations to predict a section identifier (e.g., a sub-heading identifier) for a given text section (e.g., a paragraph). The machine-learning model 500 including two prediction layers facilitates the CNN not only to learn features that identify a section identifier for a given text section, but also provide such features to contribute in identifying the section identifiers for other text sections in the unformatted text data. For example, word tokens such as “following” may not much of a factor in identifying a “body” identifier for a particular text section. However, such word tokens can be could be a strong indicator in identifying a “list” identifier for a subsequent text section. As such, features learned in a particular layer (e.g., a feature-prediction layer) can be propagated to another layer (e.g., a sequence-prediction layer), to improve accuracy in identifying section identifiers for the text sections in the unformatted and unstructured text data.

An example of section-identifier identification process includes a document-processing application to perform the following operations: (i) receiving raw, unformatted text data as input; (ii) pre-processing, tokenizing, and converting the text data into a plurality of text sections having a fixed size (e.g., 120 tokens, 128 tokens); (iii) determining statistical features from each text section; (iv) generating input embeddings for all tokens in each text section; (v) combining the input embeddings to generate an embedding matrix for each text section; (iv) applying the feature-prediction layer 505 (e.g., a CNN) to identify a feature representation for each text section; (v) enhancing the feature representation with the statistical features determines from the text section; and (iv) applying the sequence prediction layer 515 (e.g., an LSTM network) to generate section identifiers for the text sections.

The techniques implemented in the machine-learning model for identifying section identifiers in unstructured and unformatted data are advantageous over several conventional techniques. For example, conventional techniques use a trained, supervised classifier to identify heuristic-based features, including number of words, text casing (e.g., lowercase, uppercase), part-of-speech (POS) tags, and features derived from the font that are applied to the text. However, these conventional techniques in this example heavily rely on formatting information. Embodiments of the present disclosure are capable of identifying section identifiers even when the input text data is unformatted.

In another example, conventional techniques process unformatted text to identify whether a block of text corresponds to one of twenty types of section headings in legal documents. Text features including string length, percentage of capitalized characters, and presence of specific keywords are used to determine a type of section associated with a given text block. However, this conventional technique is limited to a specific type of document with previously known sections, thus cannot be implemented across various types of unstructured documents.

In yet another example, the conventional techniques include using a text segmentation technique, in which lexical similarity between neighboring paragraphs is measured. The lexical similarity is used to classify text in segments, such that each segment represents a specific topic. However, the segments cannot identify headings or sub-headings (for example) that identify a degree of relatedness between the neighboring paragraphs.

In yet another example, conventional techniques include using a word-level Recurrent Neural Network (RNN) sentence modeling layer followed by a sentence-level bidirectional Long Short-term Memory (LSTM) topic modeling layer to segment a text stream text into a number of topics. The sentence-level RNN is used to detect sudden transition in topics, which identifies when a particular topic has ended. The use of RNN and LSTM layers, however, is limited to sentence-level analysis, and, as a result, the conventional techniques fall short of identifying section identifiers for one or more text sections.

As such, the techniques implemented in the machine-learning model for identifying section identifiers in unstructured and unformatted data are advantageous over several conventional techniques, which rely on formatting information or known information over specific domains.

1. Generate an Embedding Matrix from Input Text Data

To generate an embedding matrix, the document-processing application preprocesses input text data to clean it and remove unwanted information. As referred above, the input text data can be unstructured and unformatted text data. The document-processing application may remove several punctuation and unknown characters from the input text data. However, some punctuation characters including “.”, “,”, “-”, “:”, “;”, “?”, and “!” are retained as the presence or absence of some of these punctuation characters in a text section is indicative of a particular type of section identifier for the text section. For example, lists are often preceded by a text section ending with “:”, headings generally do not contain punctuations, and body generally ends with “.”. The document-processing application divides the tokenized text data into a plurality of text sections, in which each text section is defined by a sequence of tokens ending with a newline character. Additionally or alternatively, a text section can be identified by specifying a fixed number of word tokens (e.g., 120 tokens) to be associated with the text section. As shown in FIG. 5, the document-processing application divides the input text data into five text sections, each of which having a fixed size of 120 tokens.

In some instances, the document-processing application performs a sliding window operation to obtain a plurality of text sections, with a step size of one text section. The input text data may thus be represented as a plurality of text section (equal to window size), in which each text section includes a fixed number of tokens that denote particular words.

In some instances, the document-processing application determines statistical features from each text section. The statistical features are typically determined before embedding matrices are generated for the text sections, as the statistical features depend on (for example) a syntax, part-of-speech, letter casing, and word-frequency of word tokens in the text section. For example, the statistical features include a ratio between a count of uppercase characters and a count of words in the text section. In some instances, the document-processing application uses a sliding window operation to represent the statistical features for the text section. The following diagram provides an example of statistical features that are determined from a text section “Sarah is giving a demo for feature extraction.”:

Hand-Crafted Features for each paragraph
Previous Paragraph: Welcome to our demo of feature extraction.
Current Paragraph: Sarah is giving a demo for feature extraction.

| | | |
|---|---|---|
| 1 | Number of Nouns | 4 |
| 2 | Number of Verbs | 2 |
| 3 | Number of words | 9 |
| 4 | Number of nouns/Number of words | 0.44 |
| 5 | Number of verbs/Number of words | 0.22 |
| 6 | Number of words with Title casing/Number of words | 0.11 |
| 7 | Cardinal Numbers/Number of words | 0 |
| 8 | Last character ascii | 46 |
| 9 | 1, if all words upper case, else 0 | 0 |
| 10 | Number of Sentences | 1 |
| 11 | Number of same words in last section/Number of words | 0.38 |
| 12 | Number of words with all Upper casing/Number of words | 0 |
| 13 | Number of Cardinal Numbers | 0 |

The document-processing application converts tokens of each text section into input embeddings, in which a definition of each unique word token is encoded into an input embedding. In some instances, the input embedding is a vector having one or more numerical values that represent a corresponding token. Each text section is thus represented by a sequence of vectors, in which each vector including a number of numerical values representing a particular token. In some instances, because length of each individual text section may be different, the document-processing application padded and truncated the text sections, such that each text section of the plurality of text sections corresponds to the same fixed length (e.g., 120).

The document-processing application then combines the input embeddings of the text section to generate an embedding matrix for the text section. In some instances, the document-processing application uses a pre-trained neural network (e.g., FastText), which can be further trained using unsupervised learning or supervised learning to obtain the input embeddings for the tokens of the text section.

2. Determine a Feature Representation of a Text Section by Using a Feature-Prediction Layer

The feature-prediction layer 505 then accesses the embedding matrix for each text section to generate a feature representation corresponding to the text section. In some instances, the feature-prediction layer includes a CNN that applies one or more convolutional layers to extract a feature representation of the text section. The feature representation identifies one or more semantic characteristics of each text section.

As shown in FIG. 5, the document-processing application 505 applies a time-distributed CNN layer to the text sections of the input text data, in which each text section is inputted to a corresponding CNN. In some instances, the feature-prediction layer associates each text section with a value identifying its position within the sequence of text sections, and the time-distributed CNN layer processes the position value along with the embedding matrix of the text section. The feature representation of each text section in FIG. 5 includes a set of 64 values, which can collectively identify one or more semantic characteristics corresponding to the text section.

3. Concatenate Statistical Values Associated with the Text Section

The section-statistics generator 510 then encodes the statistical features of each text section into a set of feature values and concatenates the set of feature values into the feature representation of the text section. As a result the section-statistics generator 510 facilitates enhancement of the feature representation for the text section. In some instances, the section-statistics generator 510 applies a fully connected neural network to the statistical features to derive the set of feature values for each text section. For example, the section-statistics generator 510 applies the fully connected neural network to 13 statistical features corresponding to a text section “Sarah is giving a demo for feature extraction.” (e.g., number of words, last character ascii), thereby generating a set of 32 feature values that represent the statistical features of the text section.

4. Identify a Section Identifier of a Text Section by Using a Sequence-Prediction Layer

The sequence-prediction layer 515 receives the enhanced feature representation for each of the text sections. As described above, the enhanced feature representation of a given text section includes a set of values that identify one or more semantic characteristics of the text section and the set of feature values derived from the statistical features (e.g., length-frequency, syntax characteristics) of the text section. The sequence-prediction layer 515 processes the enhanced feature representation to generate a set of output features used by a fully-connected layer (for example) for identifying the final output 520, i.e., a section identifier for the text section.

For example, as shown in FIG. 5, the sequence-prediction layer 515 receives an enhanced feature representation having a set of 96 values for each text section, in which 64 values correspond to the feature representation of the text section and 32 values correspond to the feature values derived by applying a fully connected neural network to the statistical features determined from the text section.

Continuing with the example, the sequence-prediction layer 515 processes the enhanced feature representations through two bidirectional LSTM networks, each of which having two layers with 256 hidden states (also considered as outputs since return sequence was set to “true”). As described above, each of the two bidirectional LSTM networks applies two LSTM network layers to the enhanced feature representation for each text section: (i) a first LSTM network layer trained to process input features of the text sections according to a forward sequence of text sections in the text data (e.g., first text section to last text section); and (ii) a second LSTM network layer trained to process input features of the text sections according to a reverse sequence of text sections in the text data (e.g., last text section to first text section).

After the two bidirectional LSTM layers are applied to the enhance feature representations, the sequence-prediction layer applies a dropout layer of 0.5 to the output features to reduce overfitting of the machine-learning model. Each output feature of the sequence-prediction layer includes a set of 512 values. The document-processing application applies a fully connected neural network with a softmax activation function to the output features of the text sections and generates a section identifier for each text section. In some instances, the final output 520 includes, for each text section, a probability value for each possible section identifier, in which the section identifier with highest probability value is identified as the section identifier for the text section. The final output 520 is an example of a feature generated in step 208 from process 200 described above.

### Experimental Results and Observations

In certain experiments, an example of the machine-learning model 112 implemented by a document-processing application using involving embodiments described herein was tested to evaluate its performance levels. The machine-learning model was trained on a training dataset extracted from 7000 PDF documents. A total number of data points after input preparation was 1,829,945. A window size of 5 was selected. The entire training dataset was shuffled and is split into a 70/30 train-test split to divide the training dataset. The machine-learning model was trained in batches of 200.

The machine-learning model was able to capture the variablity of the training dataset as shown by the results. The result and the confusion matrix between the predicted labels are as follows:

| | Heading | Body | List |
|---|---|---|---|
| Heading | 60,761 | 6,756 | 2,435 |
| Body | 5,744 | 241,337 | 16,305 |
| List | 1,523 | 21,012 | 118,967 |

### F1 Scores & Accuracy

| | | | F1 | |
|---|---|---|---|---|
| | Precision | Recall | Score | Support |
| Heading | 0.89 | 0.87 | 0.88 | 70,182 |
| Body | 0.90 | 0.91 | 0.90 | 264,990 |
| List | 0.86 | 0.84 | 0.85 | 145,131 |
| Accuracy | | | 0.88 | 480,303 |
| Macro Average | 0.87 | 0.87 | 0.87 | 480,303 |
| Accuracy | | | | |
| Weighted Average | 0.87 | 0.88 | 0.87 | 480,303 |
| Accuracy | | | | |

The confusion matrix indicates that a large number of text sections are correctly assigned with their respective section identifiers. The false-positive rate for misclassifying a “body” text section with “list” identifier was relatively higher than other types of text section. Such results are also reflected in the F1 scores corresponding to identification of section identifiers for the respective text sections. The “body” text sections were classified most accurately with an F1 score of 0.90, while the “list” text sections were classified least accurately with an F1 score of 0.85. Nonetheless, an overall range of F1 scores are between 0.85 and 0.90, thus indicating that the machine-learning model can accurately identify the section identifiers for the text sections.

### Example of a Computing Environment

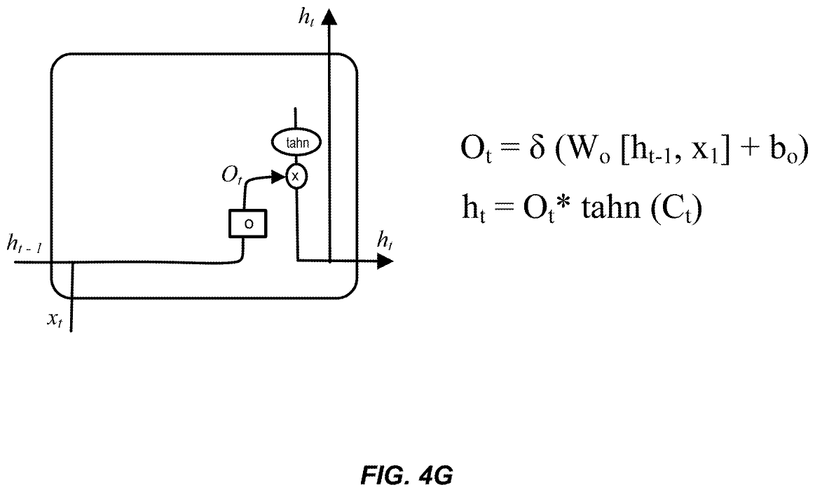

Any suitable computing system or group of computing systems can be used for performing the operations described herein. For example, FIG. 6 depicts a computing system 600 that can implement any of the computing systems or environments discussed above. In some embodiments, the computing system 600 includes a processing device 602 that executes the document-processing application 102, a memory that stores various data computed or used by the document-processing application 102, an input device 614 (e.g., a mouse, a stylus, a touchpad, a touchscreen, etc.), and an output device 616 that presents output to a user (e.g., a display device that displays graphical content generated by the document-processing application 102). For illustrative purposes, FIG. 6 depicts a single computing system on which the document-processing application 102 is executed, and the input device 614 and output device 616 are present. But these applications, datasets, and devices can be stored or included across different computing systems having devices similar to the devices depicted in FIG. 6.

The example of FIG. 6 includes a processing device 602 communicatively coupled to one or more memory devices 604. The processing device 602 executes computer-executable program code stored in a memory device 604, accesses information stored in the memory device 604, or both. Examples of the processing device 602 include a microprocessor, an application-specific integrated circuit (“ASIC”), a field-programmable gate array (“FPGA”), or any other suitable processing device. The processing device 602 can include any number of processing devices, including a single processing device.

The memory device 604 includes any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions could include processor-specific instructions generated by a compiler or an interpreter from code written in any suitable computer-programming language, including, for example, C, C++, C#, Visual Basic, Java, Python, Perl, JavaScript, and ActionScript.

The computing system 600 could also include a number of external or internal devices, such as a display device 610, or other input or output devices. For example, the computing system 600 is shown with one or more input/output (“I/O”) interfaces 608. An I/O interface 608 can receive input from input devices or provide output to output devices. One or more buses 606 are also included in the computing system 600. Each bus 606 communicatively couples one or more components of the computing system 600 to each other or to an external component.

The computing system 600 executes program code that configures the processing device 602 to perform one or more of the operations described herein. The program code includes, for example, code implementing the document-processing application 102 or other suitable applications that perform one or more operations described herein. The program code can be resident in the memory device 604 or any suitable computer-readable medium and can be executed by the processing device 602 or any other suitable processor. In some embodiments, all modules in the document-processing application 102 are stored in the memory device 604, as depicted in FIG. 6. In additional or alternative embodiments, one or more of these modules from the document-processing application 102 are stored in different memory devices of different computing systems.

In some embodiments, the computing system 600 also includes a network interface device 612. The network interface device 612 includes any device or group of devices suitable for establishing a wired or wireless data connection to one or more data networks. Non-limiting examples of the network interface device 612 include an Ethernet network adapter, a modem, and/or the like. The computing system 600 is able to communicate with one or more other computing devices (e.g., a computing device that receives inputs for document-processing application 102 or displays outputs of the document-processing application 102) via a data network using the network interface device 612.

An input device 614 can include any device or group of devices suitable for receiving visual, auditory, or other suitable input that controls or affects the operations of the processing device 602. Non-limiting examples of the input device 614 include a touchscreen, stylus, a mouse, a keyboard, a microphone, a separate mobile computing device, etc. An output device 616 can include any device or group of devices suitable for providing visual, auditory, or other suitable sensory output. Non-limiting examples of the output device 616 include a touchscreen, a monitor, a separate mobile computing device, etc.

Although FIG. 6 depicts the input device 614 and the output device 616 as being local to the computing device that executes the document-processing application 102, other implementations are possible. For instance, in some embodiments, one or more of the input device 614 and the output device 616 include a remote client-computing device that communicates with the computing system 600 via the network interface device 612 using one or more data networks described herein.

### General Considerations

Numerous specific details are set forth herein to provide a thorough understanding of the claimed subject matter. However, those skilled in the art will understand that the claimed subject matter could be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages could be used to implement the teachings contained herein in software to be used in programming or configuring a computing device.

Embodiments of the methods disclosed herein can be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values could, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, could readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method comprising:
accessing unstructured and unformatted input text data having a first text section and a second text section;
generating a first feature that represents the first text section and a second feature that represents the second text section by, at least, applying a feature-prediction layer of a machine-learning model to a first input embedding derived from the first text section and to a second input embedding derived from the second text section;
identifying a first section identifier for the first text section and a second section identifier for the second text section based on a predicted contextual relationship between the first text section and the second text section, wherein the predicted contextual relationship is determined by, at least, applying a sequence-prediction layer of the machine-learning model to the first feature and the second feature; and
generating a text document having the input text data, the first section identifier applied to the first text section, and the second section identifier applied to the second text section.

2. The method of claim 1, further comprising:
generating an enhanced first feature by concatenating the first feature with a first set of statistical features of the first text section, wherein the first set of statistical features represent syntax characteristics of the text tokens of the first text section; and
generating an enhanced second feature by concatenating the second feature with a second set of statistical features of the second text section, wherein the second set of statistical features represent syntax characteristics of the text tokens of the second text section, wherein the sequence-prediction layer of the machine-learning model is applied to the enhanced first feature and the enhanced second feature.

3. The method of claim 1, wherein the first section identifier is selected from a group consisting of: a heading identifier, a sub-heading identifier, a body identifier, and a list identifier.

4. The method of claim 1, further comprising adding a first number of text tokens to the first text section and a second number of text tokens to the second text section, such that the first text section and the second text section include the same number of tokens.

5. The method of claim 1, wherein the feature-prediction layer uses a Convolutional Neural Network (CNN), and wherein applying the feature-prediction layer includes applying two or more convolution layers of the CNN to the first input embedding and the second input embedding.

6. The method of claim 5, wherein the sequence-prediction layer uses a Long Short Term Memory (LSTM) network, wherein one or more outputs generated by applying the LSTM network are backpropagated to optimize parameters of the CNN.

7. The method of claim 1, further comprising:
modifying a first visual appearance of the first text section within the text document by accessing a first transformation rule associated with the first section identifier; and
modifying a second visual appearance of the second text section within the text document by accessing a second transformation rule associated with the second section identifier.

8. A system comprising:
an embedding-matrix module configured to generate an embedding matrix for a text section of unstructured and unformatted input text data;
a feature-prediction module configured to generate a feature representation of the text section by applying a feature-prediction layer of a machine-learning model to the embedding matrix, wherein the feature representation identifies one or more semantic characteristics of the text section;
a sequence-prediction module configured to identify a section identifier of the text section by applying a sequence-prediction layer of the machine-learning model to the feature representation, wherein the section identifier represents a type of section associated with the text section within the unstructured and unformatted input text data, and wherein the section identifier is identified by applying the feature representation with one or more weights derived from processing other feature representations of previous or subsequent text sections of the input text data; and
a document-generating module configured to generate a text document having the unstructured and unformatted input text data, wherein the section identifier is applied to the text section.

9. The system of claim 8, further comprising:
a section-statistics generating module configured to generate an enhanced feature representation by concatenating the feature representation with a set of feature values derived from statistical features that represent one or more syntactic characteristics of the text section, wherein the sequence-prediction layer is applied to the enhanced feature representation.

10. The system of claim 9, wherein the set of feature values are generated by applying a fully connected neural network to the statistical features of the text section.

11. The system of claim 9, wherein the statistical features include a quantity of a first set of text tokens of the text section, wherein text tokens of the first set of text tokens indicate a part of speech.

12. The system of claim 9, wherein the statistical features include a quantity of text tokens in the text section.

13. The system of claim 8, wherein the section identifier is selected from a group consisting of: a heading identifier, a sub-heading identifier, a body identifier, and a list identifier.

14. The system of claim 8, wherein the embedding-matrix module is configured to truncate a set of text tokens to the text section to reduce a quantity of the text tokens to a predetermined size.

15. The system of claim 8, wherein the feature-prediction layer uses a Convolutional Neural Network (CNN), and wherein applying the feature-prediction layer includes applying two or more convolution layers of the CNN to the first input embedding and the second input embedding.

16. The system of claim 15, wherein the sequence-prediction layer uses a Long Short Term Memory (LSTM) network, wherein one or more outputs generated by applying the LSTM network are backpropagated to optimize parameters of the CNN.

17. A computer program product tangibly embodied in a non-transitory machine-readable storage medium including instructions configured to cause one or more data processors to perform actions including:
identifying, for a text section of a sequence of text sections of unstructured and unformatted input text data, an embedding matrix for the text section, wherein the embedding matrix includes, for each token of the text section, an input embedding that represents the token;
a step for generating a section identifier of the text section by applying at least a sequence-prediction layer of a machine-learning model to a feature representation derived from the embedding matrix, wherein the sequence-prediction layer generates the section identifier at least in part by detecting transitions between the text section and a previous text section in the sequence of text sections; and
outputting the graph structure.

18. The computer program product of claim 17, wherein the feature representation is derived by applying a convolutional neural network (CNN) of the machine-learning model to the embedding matrix.

19. The computer program product of claim 18, wherein the sequence-prediction layer uses a bidirectional Long Short Term Memory (LSTM) network to generate the section identifier, wherein learned parameters from applying the LSTM network are propagated to adjust parameters of the CNN.

20. The computer program product of claim 17, further comprising instructions configured to cause one or more data processors to perform actions including generating an enhanced feature representation by concatenating the feature representation with a set of feature values derived from statistical features that represent one or more syntactic characteristics of the text section, wherein the sequence-prediction layer is applied to the enhanced feature representation to generate the section identifier.
